(19) United States
(12) Patent Application Publication
(10) Pub. No.: US 2026/0277619 A1
(43) Pub. Date: Sep. 17, 2026

(54) INFORMATION PROCESSING APPARATUS AND CONTROL METHOD

(71) Applicant: Lenovo (Singapore) Pte. Ltd., Singapore (SG)

(72) Inventors: Ken Sasaki, Kanagawa (JP); Yusaku Morishige, Kanagawa (JP); Naoyuki Araki, Kanagawa (JP); Ryo Fukuda, Kanagawa (JP)

(73) Assignee: Lenovo (Singapore) Pte. Ltd., Singapore (SG)

(21) Appl. No.: 19/367,574

(22) Filed: Oct. 23, 2025

(30) Foreign Application Priority Data
Oct. 31, 2024 (JP) 2024-191747

(51) Int. Cl. G06F 9/4401; G06F 12/06

(52) U.S. Cl. CPC G06F 9/4403; G06F 12/06

(57) ABSTRACT

An information processing apparatus includes: a processor that executes BIOS processing; and a memory that temporarily stores pieces of data to be accessed by the BIOS processing. The processor is configured to store data location information indicating a location within the memory of some of the pieces of data in an area separate from an area in the memory where the pieces of data is stored; and when accessing one of the pieces of data stored in the memory through the BIOS processing, if the data location information on the data to be accessed is not stored in the memory, access the data by searching the pieces of data stored in the memory in a predetermined order, and if the data location information on the data to be accessed is stored in the memory, access the data in accordance with the data location information.

### CROSS-REFERENCE TO RELATED APPLICATIONS

This application claims priority to Japanese Patent Application No. 2024-191747 filed on Oct. 31, 2024, the contents of which are hereby incorporated herein by reference in their entirety.

### TECHNICAL FIELD

Embodiments of the present invention relates to an information processing apparatus and a control method.

### BACKGROUND

Conventionally, information processing apparatuses such as personal computers (PCs) are configured so that, when the power is turned on, the basic input output system (BIOS) executes the power on self test (POST) process, and then executes the OS (operating system) boot process. The POST process detects each piece of hardware in the information processing apparatus and performs initial settings for the hardware (see, for example, Japanese Unexamined Patent Application Publication No. 2014-10492).

Such information processing apparatuses are required to shorten the time needed for the start-up of the computer to enhance the user convenience, and thus are always required to decrease the POST time. For instance, during the POST process, BIOS data is accessed tens of thousands of times, making it necessary to speed up the access. Conventionally, data stored in nonvolatile storage is copied to a random access memory (RAM) and cached for speeding up.

The data that the BIOS accesses during the POST process includes multiple variables, and each variable has an identifier. To access a variable with a certain identifier, the BIOS searches for the variable with a matching identifier from the beginning of the multiple variables copied in the RAM one by one. Therefore, it takes time to access a variable stored closer to the end of the variables, and the access time increases as the number of variables increases. If tens of thousands of accesses occur during the POST process, the POST time becomes long, and just a conventional method of caching in a RAM is not sufficient to speed up an access to the BIOS data.

### SUMMARY

Embodiments of the present invention provide an information processing apparatus and a control method capable of speeding up an access to data by the BIOS.

An information processing apparatus according to the first aspect of the present invention includes: a processor that executes BIOS (basic input output system) processing; and a memory that temporarily stores a plurality of pieces of data to be accessed by the BIOS processing, the processor being configured to: store data location information indicating a location within the memory of some of the plurality of pieces of data stored in the memory through the BIOS processing in an area separate from an area in the memory where the plurality of pieces of data is stored; and when accessing one of the plurality of pieces of data stored in the memory through the BIOS processing, if the data location information on the data to be accessed is not stored in the memory, access the data by searching the plurality of pieces of data stored in the memory in a predetermined order, and if the data location information on the data to be accessed is stored in the memory, access the data in accordance with the data location information.

In the information processing apparatus, the processor may, in response to accessing to any of the plurality of pieces of data stored in the memory through the BIOS processing, store the data location information of the accessed data in the memory.

In the information processing apparatus, each of the plurality of pieces of data may be stored in the memory in association with identification information of the data, and the processor may be configured to, in response to accessing to any of the plurality of pieces of data, associate the identification information of the accessed data with the data location information and store the associated information in the memory.

In the information processing apparatus, the processor may be configured to, when reading one of the plurality of pieces of data through the BIOS processing, if the data location information on the data to be read is not stored in the memory, access and read the data by searching the plurality of pieces of data stored in the memory in a predetermined order, and if the data location information on the data to be read is stored in the memory, access and read the data in accordance with the data location information.

In the information processing apparatus, the plurality of pieces of data may include: first data that may be written during the power on self test (POST) processing by the BIOS processing but not be written after the POST processing; and second data that may be written both during the POST processing and after the POST processing, and the processor may be configured to, when storing the data location information in the memory, store the data location information on the first data and the data location information on the second data separately in a first area and a second area in the memory.

In the information processing apparatus, the processor may be configured to, when writing to one of the plurality of pieces of data through the BIOS processing, invalidate the data before writing and write the data to another location within the memory, and when accessing and writing the data in accordance with the data location information stored in the first area or the second area, update the data location information based on the location of the data in the memory after writing.

In the information processing apparatus, the processor may be configured to, when accessing and writing the data based on the data location information stored in the first area, and when updating the data location information, erase all of the data location information currently stored in the first area, and then store the data location information indicating the location in the memory of the data after writing in the first area; and when accessing and writing the data based on the data location information stored in the second area, and when updating the data location information, erase all of the data location information currently stored in the second area, and then store the data location information indicating the location in the memory of the data after writing in the second area.

In the information processing apparatus, the processor may be configured to prohibit erasure of the data location information stored in the first area after the POST processing.

In the information processing apparatus, the processor may be configured to, at a start of the POST processing, initialize the first area and the second area to a state in which the data location information is not stored.

In the information processing apparatus, the memory may include a volatile memory that copies and temporarily stores BIOS data stored in a non-volatile memory.

A control method for an information processing apparatus according to the second aspect of the present invention includes: a processor that executes BIOS (basic input output system) processing; and a memory that temporarily stores a plurality of pieces of data to be accessed by the BIOS processing, the processor performing: storing data location information indicating a location within the memory of some of the plurality of pieces of data stored in the memory through the BIOS processing in an area separate from an area in the memory where the plurality of pieces of data is stored; and when accessing one of the plurality of pieces of data stored in the memory through the BIOS processing, if the data location information on the data to be accessed is not stored in the memory, accessing the data by searching the plurality of pieces of data stored in the memory in a predetermined order, and if the data location information on the data to be accessed is stored in the memory, accessing the data in accordance with the data location information.

One or more embodiments of the present invention speed up an access to data by the BIOS.

### BRIEF DESCRIPTION OF THE DRAWINGS

FIG. 1 is a block diagram illustrating one example of the hardware configuration of the information processing apparatus according to one or more embodiments.

FIG. 2 is a schematic diagram of BIOS data expanded from the ROM to the RAM according to one or more embodiments.

FIG. 3 schematically illustrates an example of a process for searching for a variable during access according to one or more embodiments.

FIG. 4 is a block diagram illustrating one example of the functional configuration of the information processing apparatus according to one or more embodiments when data access is performed using the predictive pointer cache.

FIG. 5 schematically illustrates an overview of a data access method using a predictive pointer cache according to one or more embodiments.

FIG. 6 schematically illustrates an example of the process when a variable pointer of a variable to be read-accessed is registered according to one or more embodiments.

FIG. 7 schematically illustrates an example of the process when a variable pointer of a variable to be read-accessed is not registered according to one or more embodiments.

FIG. 8 schematically illustrates an example of a write access process during POST processing according to one or more embodiments.

FIG. 9 schematically illustrates an example of the control for predictive pointer cache for protection according to one or more embodiments.

FIG. 10 schematically illustrates an example of a write access process after POST processing according to one or more embodiments.

FIG. 11 schematically illustrates an example of speeding up a data access according to one or more embodiments.

FIG. 12 illustrates an example of the advantageous effect of speeding up a data access according to one or more embodiments.

FIG. 13 is a flowchart of one example of the data access process during a read access according to one or more embodiments.

FIG. 14 is a flowchart of one example of the data access process for a write access during the POST processing according to one or more embodiments.

FIG. 15 is a flowchart of one example of the data access process for a write access after the POST processing according to one or more embodiments.

### DETAILED DESCRIPTION

The following describes one or more embodiments of the present invention, with reference to the attached drawings.

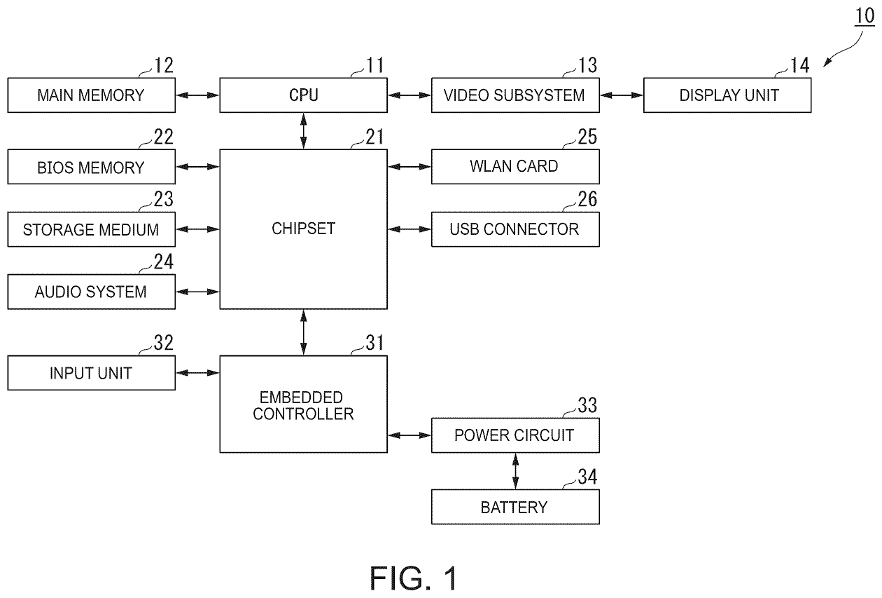

The information processing apparatus 10 according to one or more embodiments is a computer, such as a clamshell (laptop) personal computer, desktop personal computer, tablet terminal, or smartphone. First, referring to FIG. 1, the following describes an example of the hardware configuration of the information processing apparatus according to one or more embodiments.

FIG. 1 is a block diagram illustrating one example of the hardware configuration of the information processing apparatus 10 according to one or more embodiments. The information processing apparatus 10 includes a CPU 11, a main memory 12, a video subsystem 13, a display unit 14, a chipset 21, a BIOS memory 22, a storage medium 23, an audio system 24, a WLAN card 25, a USB connector 26, an embedded controller 31, an input unit 32, a power circuit 33, and a battery 34.

The CPU 11 executes different types of arithmetic processing under the control of a program to control the information processing apparatus 10 as a whole. For instance, the CPU 11 executes processing based on the operating system (OS) and basic input output system (BIOS) programs. The CPU 11 is an example of the processor.

The main memory 12 includes a random access memory (RAM), and is a volatile memory functioning as a read-in area of a program executed by the CPU 11 or a work area to write data processed by the executed program. For instance, the main memory 12 includes a plurality of dynamic random access memory (DRAM) chips. The program executed includes an OS, various types of drivers to operate peripherals as hardware, various types of service/utility and application programs.

The video subsystem 13 is a subsystem to implement the functions related to image displaying, and includes a video controller. The video controller processes a drawing instruction from the CPU 11 and writes the processed drawing information on a video memory. The video controller also reads this drawing information from the video memory and outputs the drawing information as drawing data (display data) to the display unit 14.

For instance, the display unit 14 is a liquid crystal display or an organic EL display, and displays an image screen based on the drawing data (display data) output from the video subsystem 13.

The chipset 21 includes a controller, such as universal serial bus (USB), serial AT attachment (ATA), serial peripheral interface (SPI) bus, peripheral component interconnect (PCI) bus, PCI-Express bus, or low pin count (LPC) bus, and a plurality of devices are connected to the chipset 21. For instance, the plurality of devices include the BIOS memory 22, the storage medium 23, the audio system 24, the WLAN card 25, the USB connector 26, and the embedded controller 31, which will be described later.

The BIOS memory 22 includes a non-volatile memory (non-volatile storage) that stores BIOS data, such as a flash read only memory (ROM) or an electrically erasable programmable read only memory (EEPROM). The BIOS memory 22 stores BIOS, and system firmware (programs) and data to control the embedded controller 31, for example.

The storage medium 23 includes a hard disk drive (HDD), a solid state drive (SSD) and others. For instance, the storage medium 23 stores an OS, various drivers, various services/utilities, application programs, and various data.

The audio system 24, to which a microphone and a speaker not illustrated are connected, records, reproduces, and outputs audio data. In one example, the microphone and the speaker are built in the information processing apparatus 10.

The wireless local area network (WLAN) card 25 connects to a network via wireless LAN for data communication. When receiving data from the network, for example, the WLAN card 25 generates an event trigger indicating the data reception. The USB connector 26 is to connect peripherals using USB.

The input unit 32 collectively refers to input devices in the information processing apparatus 10. The input unit 32 includes a keyboard and a mouse. The input unit 32 outputs input information input by a user's operation to the embedded controller 31.

The power circuit 33 includes a DC/DC converter, a charge-discharge unit, and an AC/DC adaptor. For instance, the power circuit 33 converts DC voltage supplied from an external power source such as an AC adapter (not illustrated) or the battery 34 into the multiple levels of voltage required to operate the information processing apparatus 10. The power circuit 33 supplies electricity to different parts of the information processing apparatus 10 under the control of the embedded controller 31.

For instance, the battery 34 includes a secondary battery, such as a lithium ion battery. When power is supplied from an external power supply, the battery 34 is charged with the power through the power circuit 33. When power is not supplied to the information processing apparatus 10 from an external power supply, the battery 34 outputs the stored power as the operating power of the information processing apparatus 10 via the power circuit 33.

The embedded controller 31 is a one-chip microcomputer to monitor and control various devices (e.g., peripherals and sensors), irrespective of the system state of the information processing apparatus 10. The embedded controller 31 includes a CPU, a ROM, a RAM, and an A/D input terminal, a D/A output terminal, a timer, and a digital input/output terminal for a plurality of channels, which are not illustrated. The embedded controller 31 connects with the input unit 32, the power circuit 33 and others via its digital input/output terminal, and the embedded controller 31 controls the operation of these components.

Next, the following describes a method for accessing data by the BIOS.

The BIOS data is stored in the BIOS memory 22 (ROM). At start-up, this data is copied to the main memory 12 (RAM) and expanded, and the copy (cache) in this RAM is accessed, which is faster than accessing the ROM.

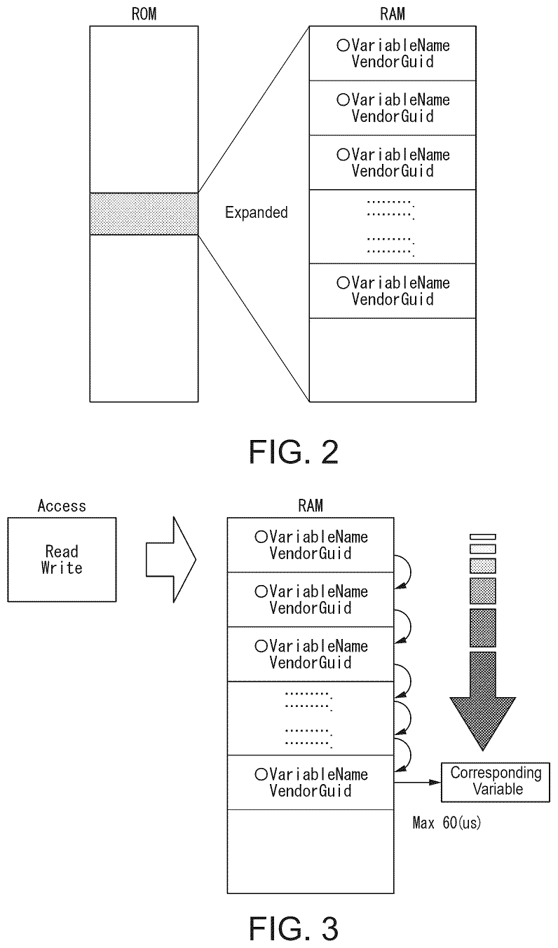

FIG. 2 is a schematic diagram of BIOS data expanded from the ROM to the RAM. For instance, in a UEFI BIOS that uses unified extensible firmware interface (UEFI), multiple UEFI variables are stored as BIOS data. The UEFI variables each have an identifier for identifying it. For instance, the identifiers include two identifiers: a variable name and a vendor globally unique identifier (GUID). In the following description, “UEFI variables” will be referred to simply as “variables.” Variables that are expanded (copied) into the RAM are stored as a set of identifiers and variable values. When accessing (reading/writing), the corresponding variable is searched for by the identifier. In this way, the conventional approach to speeding up the access has been to expand BIOS data from a ROM to a RAM and cache it.

However, to access a variable with a certain identifier, a variable with a matching identifier must be searched for one by one from the beginning of the RAM, meaning that an access to variables stored closer to the end takes time.

FIG. 3 schematically illustrates an example of a process for searching for a variable during access (reading/writing). As illustrated in this drawing, if the variable to be accessed (to be read/written) is stored closer to the end of the RAM, the access time will increase because it will be searched for one by one from the beginning (e. g., in the current POST process, it takes up to about 60 μs). As the number of variables increases, the access time increases. Furthermore, when tens of thousands of accesses occur as in the current POST process, the time required for the overall POST process increases with the number of accesses, so there is a demand for further speeding up.

Thus, one or more embodiments use a predictive pointer cache to directly access variables (cache) expanded in the RAM to achieve high speed. A predictive pointer cache is data that contains address (offset) information (hereinafter referred to as “variable pointer”) indicating the location in the RAM of a variable that is predicted to be accessed. This data is stored in an area in the RAM separate from the area where multiple variable data are stored.

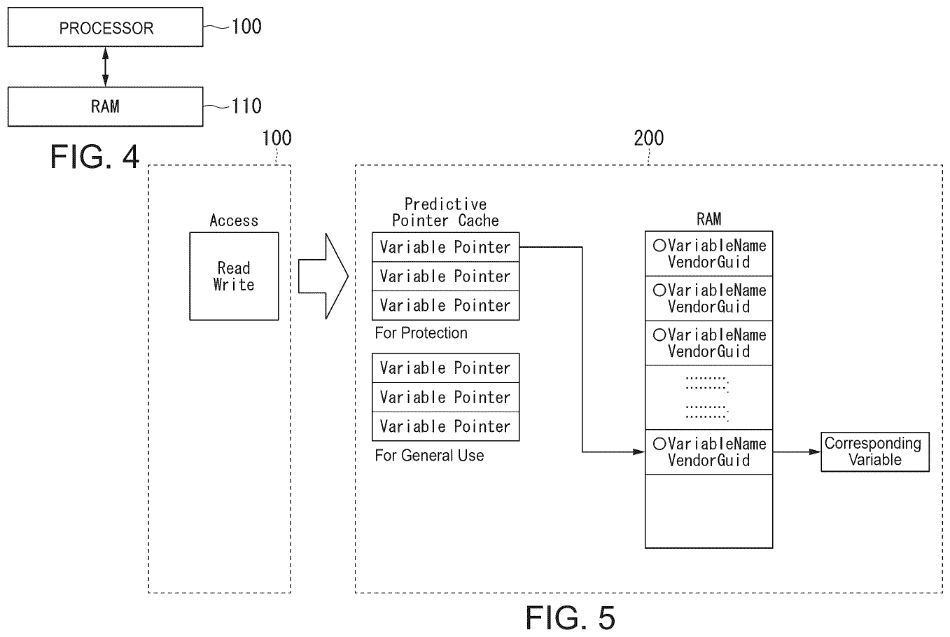

FIG. 4 is a block diagram illustrating one example of the functional configuration of the information processing apparatus 10 according to one or more embodiments when data access is performed using the predictive pointer cache. The information processing apparatus 10 includes a processor 100 and a RAM 110. For instance, the processor 100 has a functional configuration such that a processor such as the CPU 11 executes BIOS processing based on a BIOS program. The RAM 110 is a volatile memory such as the main memory 12, and BIOS data is copied to the RAM 110 at start-up and is expanded as cache data. The processor 100 uses the predictive pointer cache to access the cache data expanded in the RAM 110.

### Overview of Data Access Method

FIG. 5 schematically illustrates an overview of a data access method using a predictive pointer cache according to one or more embodiments. Variables include those that require write protection to prevent writing and those that do not require write protection. Therefore, the predictive pointer cache is divided into a predictive pointer cache for protection to register variable pointers of variables that need to be write-protected, and a predictive pointer cache for general use to register variable pointers of variables that do not need to be write-protected, and they are stored in different areas within the RAM 110.

Variables that need to be write-protected are variables that may be written to during the BIOS power on self test (POST) processing, but will not be written to after the POST processing (during runtime). To protect the BIOS data configuration (settings), variable pointers that are write-restricted and cannot be changed after the POST processing (during runtime) are registered in the predicted pointer cache for protection. The predictive pointer cache for protection is maintained after the POST processing (during runtime). In contrast, variables that do not need to be write-protected are variables to which writing may occur both during and after the POST processing.

When the processor 100 accesses (reads/writes) a variable (cache) expanded in the RAM 110, if the variable pointer of the variable is not registered in the predictive pointer cache, the processor 100 accesses the variable by searching the multiple variables stored in the RAM 110 one by one from the beginning (see FIG. 3).

In contrast, when accessing (reading/writing) a variable (cache) expanded in the RAM 110, if the variable pointer of the variable is registered in the predictive pointer cache (for protection or general use), the processor 100 directly accesses the variable at the address indicated by the variable pointer. This saves time in searching the RAM 110 from the beginning when the variable to be accessed is a variable for which a variable pointer is registered in the predictive pointer cache, thereby reducing the access time.

Next, the following is detailed descriptions of a data access using the predictive pointer cache described with reference to FIG. 5 during read access and during write access.

### Read Access

First, read access will be described.

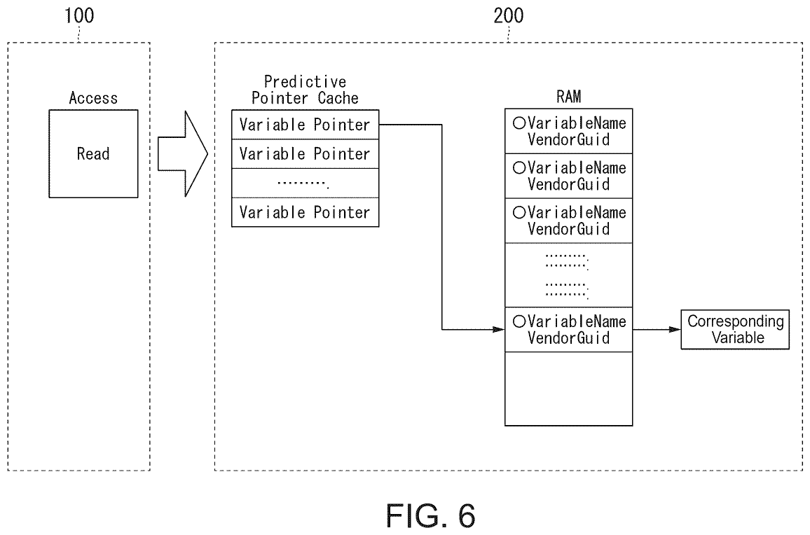

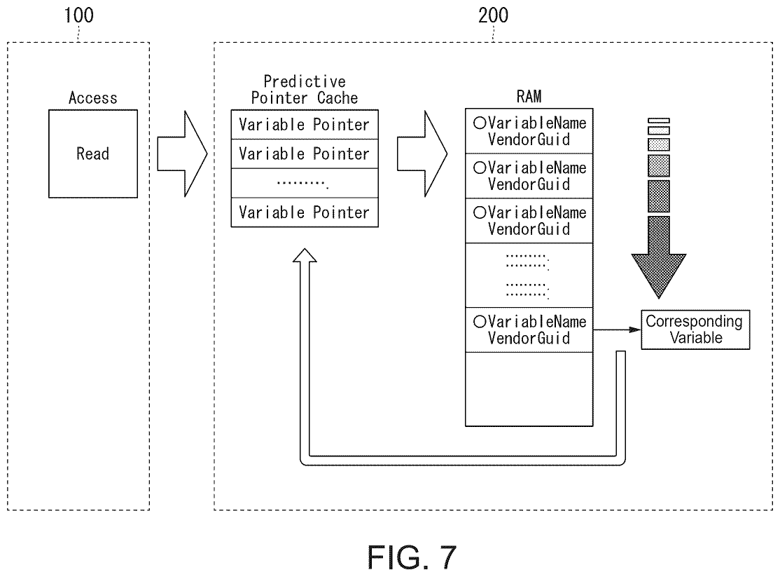

FIG. 6 and FIG. 7 schematically illustrate an example of a read access using a predictive pointer cache according to one or more embodiments. During read access, no writing occurs during or after POST processing, and the predictive pointer cache is used in the same way between for protection and for general use. Thus, FIG. 6 and FIG. 7 illustrate the predictive pointer cache without distinction between for protection and for general use. Although no distinction is made between for protection and for general use, a variable pointer of a variable that needs to be write-protected after POST processing (during runtime) is registered in the predictive pointer cache for protection, and a variable pointer of a variable that does not need write-protection both during POST processing and after POST processing (during runtime) is registered in the predictive pointer cache for general use.

FIG. 6 schematically illustrates an example of the process when a variable pointer of a variable to be read-accessed is registered. When the processor 100 performs a read access to variables expanded in the RAM 110, it compares all variable pointers registered in the predictive pointer caches both for protection and for general use with the identifier of the variable (of the variable to be read-accessed). If the variable pointer that matches the identifier of this variable is registered in the predictive pointer cache, the processor 100 accesses the address indicated by the matching variable pointer and reads the value (data) of the variable.

FIG. 7 schematically illustrates an example of the process when a variable pointer of a variable to be read-accessed is not registered. When the processor 100 performs a read access to variables expanded in the RAM 110, it compares all variable pointers registered in the predictive pointer caches both for protection and for general use with the identifier of the variable (of the variable to be read-accessed). If the variable pointer that matches the identifier of this variable is not registered in the predictive pointer cache, the processor 100 accesses multiple variables stored in the RAM 110 one by one from the beginning to read the value (data) of the variable that matches in identifier.

The processor 100 then registers the variable pointer of the accessed variable in the predictive pointer cache in the RAM 110. For instance, if the accessed variable is a variable that needs to be write-protected, the processor 100 registers its variable pointer in the predictive pointer cache for protection, and if the accessed variable is a variable that does not need to be write-protected, the processor 100 registers its variable pointer in the predictive pointer cache for general use.

### Write Access During POST Processing

Next, the following describes a write access during POST processing.

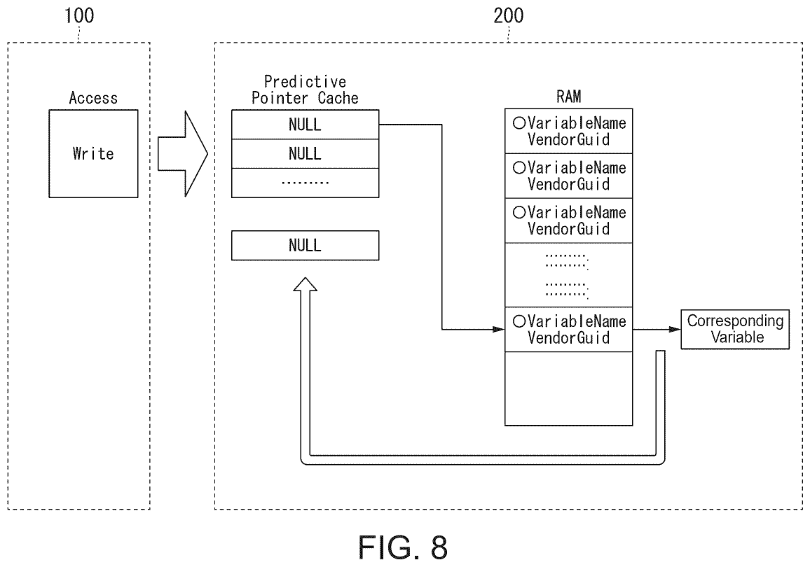

FIG. 8 schematically illustrates an example of a write access process during POST processing. During a write access during POST processing, no variables are write-protected. Thus, the predictive pointer cache is used in the same way between for protection and for general use. Thus, FIG. 8 illustrates the predictive pointer cache without distinction between for protection and for general use. Although no distinction is made between for protection and for general use, a variable pointer of a variable that needs to be write-protected after POST processing (during runtime) is registered in the predictive pointer cache for protection, and a variable pointer of a variable that does not need write-protection both during POST processing and after POST processing (during runtime) is registered in the predictive pointer cache for general use.

When the processor 100 performs a write access to variables expanded in the RAM 110, it compares all variable pointers registered in the predictive pointer caches both for protection and for general use with the identifier of the variable (of the variable to be write-accessed). If the variable pointer that matches the identifier of this variable is registered in the predictive pointer cache, the processor 100 accesses the address indicated by the matching variable pointer and writes the value (data) to the variable. Then the processor 100 writes back it to the BIOS memory 22 (nonvolatile storage) for synchronization (updating) of the data stored in the BIOS memory 22.

Although not illustrated in the drawing, if the variable pointer that matches the identifier of this variable is not registered in the predictive pointer cache, the processor 100 searches for multiple variables stored in the RAM 110 one by one from the beginning in the similar manner as for the read access illustrated in FIG. 7. Then, the processor 100 searches for the variables one by one from the beginning to access the variable with the matching identifier, writes the value (data), and writes it back to the BIOS memory 22 (non-volatile storage) for synchronization (updating) of the data stored in the BIOS memory 22.

The processor 100 then registers the variable pointer of the accessed variable in the predictive pointer cache in the RAM 110. For instance, if the accessed variable is a variable that needs to be write-protected, the processor 100 registers its variable pointer in the predictive pointer cache for protection, and if the accessed variable is a variable that does not need to be write-protected, the processor 100 registers its variable pointer in the predictive pointer cache for general use.

Here, when data is written during a write access, the address of the corresponding variable (the written variable) changes. Specifically, during a write access, the processor 100 invalidates the variable before writing and writes the corresponding variable to a different address in the RAM 110. This means that, when registering a variable pointer of the variable for which data has been written, the processor 100 flushes (erases) the predictive pointer cache for registration, regardless of whether the data is registered in the predictive pointer cache for protection or for general use, and then registers the variable pointer indicating the address after writing. The predictive pointer cache illustrated in this drawing is in a flushed (erased) state (NULL) because the data has been written. After that, the variable pointer is registered.

### Switching of Predictive Pointer Cache for Protection

Next, the following describes switching of predictive pointer cache for protection.

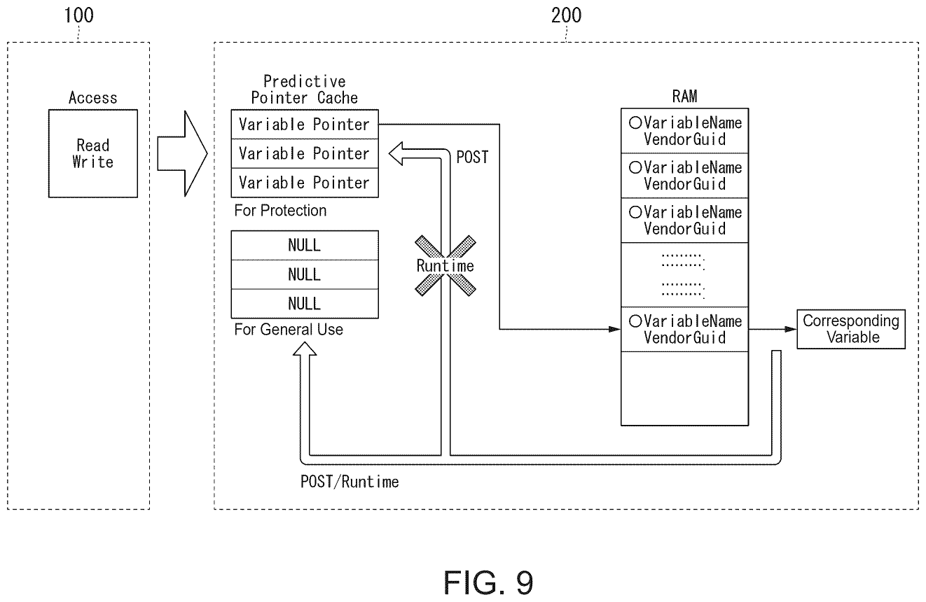

FIG. 9 schematically illustrates an example of the control for predictive pointer cache for protection. Variables that need to be write-protected are written during the POST processing. This means that, during the POST processing, when writing is performed to a variable due to a write access, the predictive pointer cache is flushed (erased) both for the predictive pointer cache for protection and the predictive pointer cache for general use before the variable pointer is registered.

After the POST processing (during runtime), however, writing to variables that need to be write-protected is restricted, so predictive pointer cache for protection does not change. For instance, to protect the BIOS data configuration (settings), writing is restricted and no changes can be made after the POST processing (during runtime). This means that the predictive pointer cache for protection is maintained after the POST processing (during runtime). For instance, the processor 100 may use the “UEFI Exit Boot Service” as a trigger, which is used for terminating BIOS boot, to prohibit flushing (erasing) of the predictive pointer cache for protection. This allows the processor 100 to use a variable pointer registered in the predictive pointer cache for protection also when accessing after the POST processing (during runtime).

### Write Access After POST Processing

Next, the following describes a write access after the POST processing, to which the above-described switching control of the predictive pointer cache for protection has been applied. Note that, if the request is for writing to a variable that needs write protection, the processor 100 does not process the write access and returns an error.

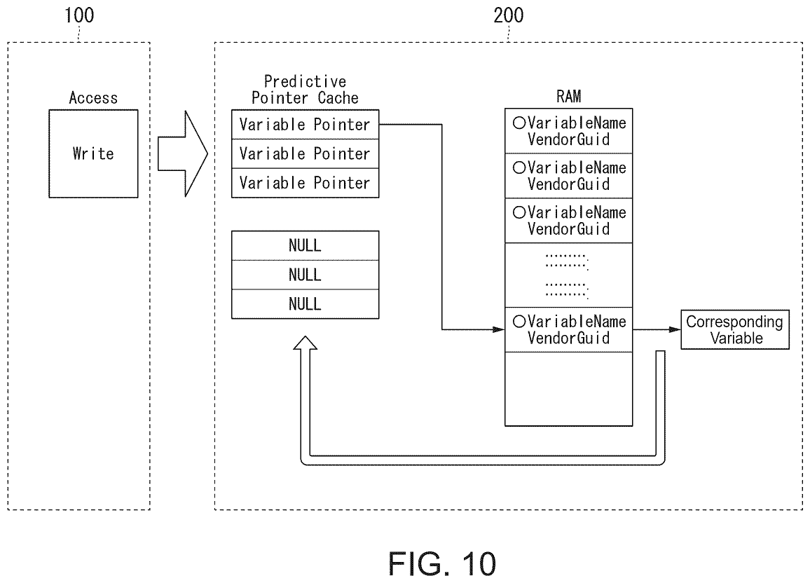

FIG. 10 schematically illustrates an example of a write access process for a variable that does not need write protection after POST processing (during runtime).

When the processor 100 performs a write access to variables expanded in the RAM 110, it compares all variable pointers registered in the predictive pointer caches both for general use with the identifier of the variable (of the variable to be write-accessed). If the variable pointer that matches the identifier of this variable is registered in the predictive pointer cache, the processor 100 accesses the address indicated by the matching variable pointer and writes the value (data) to the variable.

Although not illustrated in the drawing, if the variable pointer that matches the identifier of this variable is not registered in the predictive pointer cache, the processor 100 searches for multiple variables stored in the RAM 110 one by one from the beginning in the similar manner as for the read access illustrated in FIG. 7. Then, the processor 100 searches for the variables one by one from the beginning to access the variable with the matching identifier, and writes the value (data).

The processor 100 then registers the variable pointer of the accessed variable in the predictive pointer cache in the RAM 110. At this time, the processor 100 registers the variable pointer in the predictive pointer cache for general use (registers after flushing), but the predictive pointer cache for protection is maintained.

### Example of Speeding Up Data Access

The following is an example of how access to data is speeded up by the data access method using the predictive pointer cache described referring to FIG. 5 through FIG. 10.

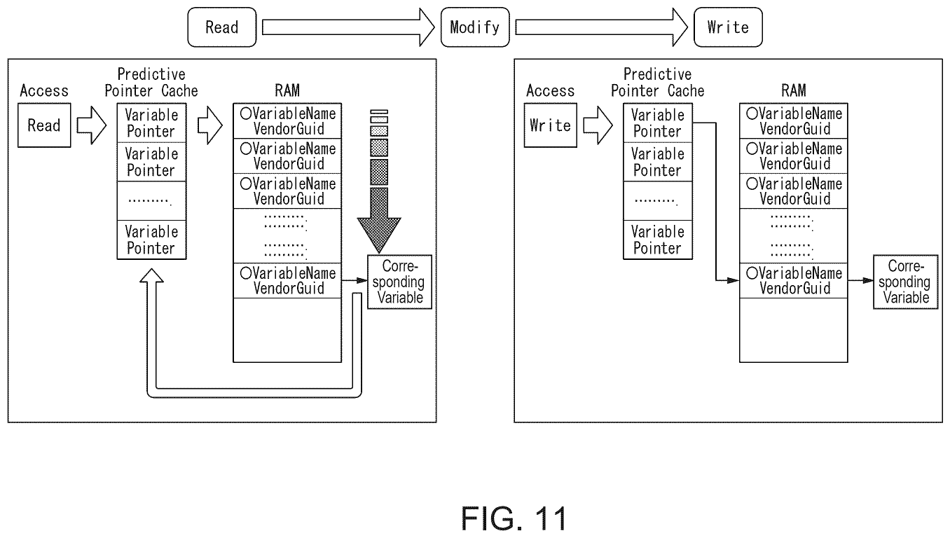

FIG. 11 schematically illustrates an example of speeding up a data access according to one or more embodiments. This drawing illustrates the example in which the processor 100 performs a series of processes to change the value (data) of a variable, including reading the value (data) of the variable and writing the modified value to the variable. For instance, the processor 100 registers the variable pointer of the accessed variable in the predictive pointer cache during a read access. Then, when writing a changed value, the processor 100 is allowed to use the registered variable pointer to directly access the address indicated by the variable pointer without searching from the beginning. When the value (data) of a variable is changed, the processor 100 performs the process of reading the variable and writing to the variable each time, thus reducing the access time.

Although FIG. 11 illustrates an example of the process of reading a variable and writing to the variable, access time can be shortened by using the registered variable pointer also when the read variable is read again.

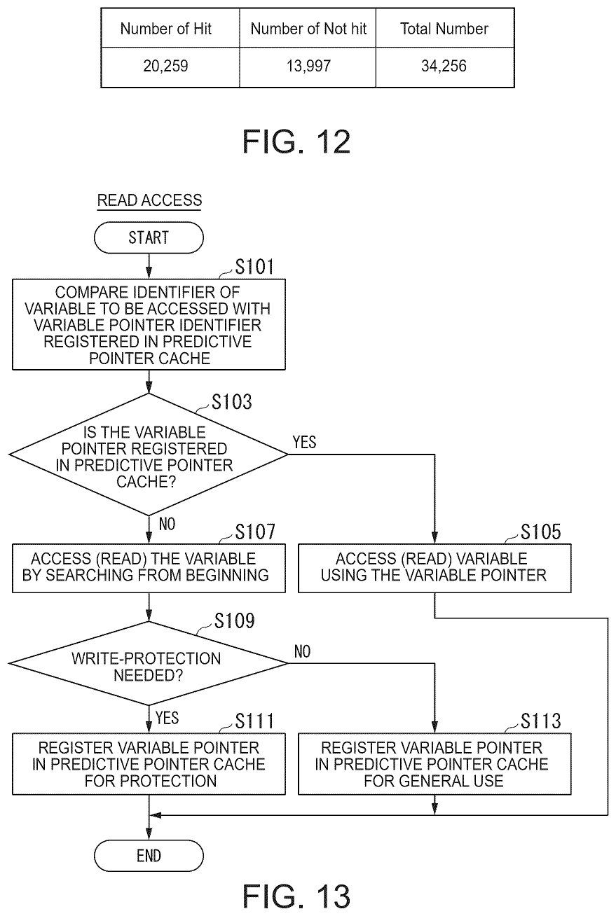

FIG. 12 illustrates an example of the advantageous effect of speeding up a data access according to one or more embodiments. An experiment was carried out for approximately 500 variables, where a predictive pointer cache was set up so that three variable pointers were able to be registered each for protection and for general use, and the variable pointers of the matching variables were registered. The experiment result showed that 20, 259 variable pointers matched for 34, 256 accesses, and the access time was shortened by about 600 ms.

### Data Access Processing Operation Using Predictive Pointer Cache

Next, the following describes the operation of the processing in which the processor 100 accesses variables (cache data) expanded in the RAM 110 by using the predictive pointer cache through BIOS processing. FIG. 13 is a flowchart of one example of the data access process during a read access according to one or more embodiments.

(Step S101) The processor 100 compares the identifier of the variable to be read-accessed with the identifier of a variable pointer registered in the predictive pointer cache. Then, the procedure proceeds to step S103.

(Step S103) The processor 100 determines, based on the comparison result at step S101, whether the variable pointer of the variable to be read-accessed is registered in the predictive pointer cache. If the processor 100 determines that the variable pointer of the variable to be read-accessed is registered in the predictive pointer cache (step S103: YES), the procedure proceeds to step S105. If the processor 100 determines that the variable pointer of the variable to be read-accessed is not registered in the predictive pointer cache (step S103: NO), the procedure proceeds to step S107.

(Step S105) The processor 100 accesses the variable (variable to be read-accessed) using the variable pointer that was determined to be registered in step S103, and reads the value (data) of this variable. This completes the read access process.

(Step S107) The processor 100 accesses the multiple variables stored in the RAM 110 by searching them one by one from the beginning, and reads the value (data) of the variable (variable to be read-accessed) whose identifier matches. Then, the procedure proceeds to step S109.

(Step S109) The processor 100 determines whether the variable read-accessed in step S107 is a variable that needs to be write-protected. Here, a variable that needs to be write-protected is a variable that needs to be write-protected after POST processing (during runtime). If the processor 100 determines that the variable needs to be write-protected (step S109: YES), the procedure proceeds to step S111. If the processor 100 determines that the variable does not need to be write-protected (step S109: NO), the procedure proceeds to step S113.

(Step S111) The processor 100 registers the variable pointer of the variable read-accessed in step S107 in the predictive pointer cache for protection and ends the read access process.

(Step S113) The processor 100 registers the variable pointer of the variable read-accessed in step S107 in the predictive pointer cache for general use and ends the read access process.

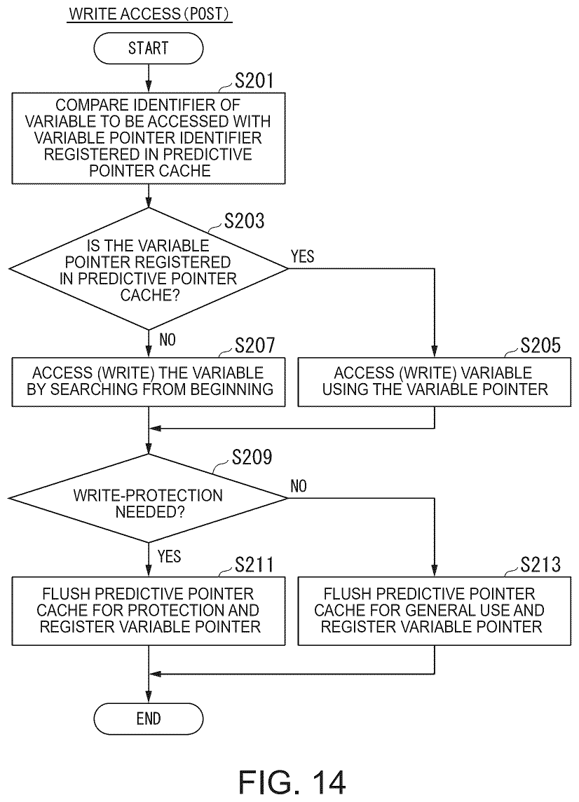

FIG. 14 is a flowchart of one example of the data access process for a write access during the POST processing according to one or more embodiments.

(Step S201) The processor 100 compares the identifier of the variable to be write-accessed with the identifier of a variable pointer registered in the predictive pointer cache. Then, the procedure proceeds to step S203.

(Step S203) The processor 100 determines, based on the comparison result at step S201, whether the variable pointer of the variable to be write-accessed is registered in the predictive pointer cache. If the processor 100 determines that the variable pointer of the variable to be write-accessed is registered in the predictive pointer cache (step S203: YES), the procedure proceeds to step S205. If the processor 100 determines that the variable pointer of the variable to be write-accessed is not registered in the predictive pointer cache (step S203: NO), the procedure proceeds to step S207.

(Step S205) The processor 100 accesses the variable (variable to be write-accessed) using the variable pointer that was determined to be registered in step S203, and writes the value (data) to this variable. Specifically, the processor 100 invalidates the variable before it was written, writes the variable to another address in the RAM 110, and writes it back to the BIOS memory 22 (non-volatile storage) for synchronization (updating) of the data stored in the BIOS memory 22. This completes the write access process.

(Step S207) The processor 100 accesses the multiple variables stored in the RAM 110 by searching them one by one from the beginning, and writes the value (data) to the variable (variable to be write-accessed) whose identifier matches. Specifically, the processor 100 invalidates the variable before writing and writes the corresponding variable to another address in the RAM 110. Then, the procedure proceeds to step S209.

(Step S209) The processor 100 determines whether the variable write-accessed in step S207 is a variable that needs to be write-protected. Here, a variable that needs to be write-protected is a variable that needs to be write-protected after POST processing (during runtime). If the processor 100 determines that the variable needs to be write-protected (step S209: YES), the procedure proceeds to step S211. If the processor 100 determines that the variable does not need to be write-protected (step S209: NO), the procedure proceeds to step S213.

(Step S211) The processor 100 registers a variable pointer indicating the address after writing the write-accessed variable in step S207. Specifically, the processor 100 flushes (erases) the predictive pointer cache for protection, and then registers the variable pointer to end the write access process.

(Step S213) The processor 100 registers a variable pointer indicating the address after writing the write-accessed variable in step S207. Specifically, the processor 100 flushes (erases) the predictive pointer cache for general use, and then registers the variable pointer to end the write access process.

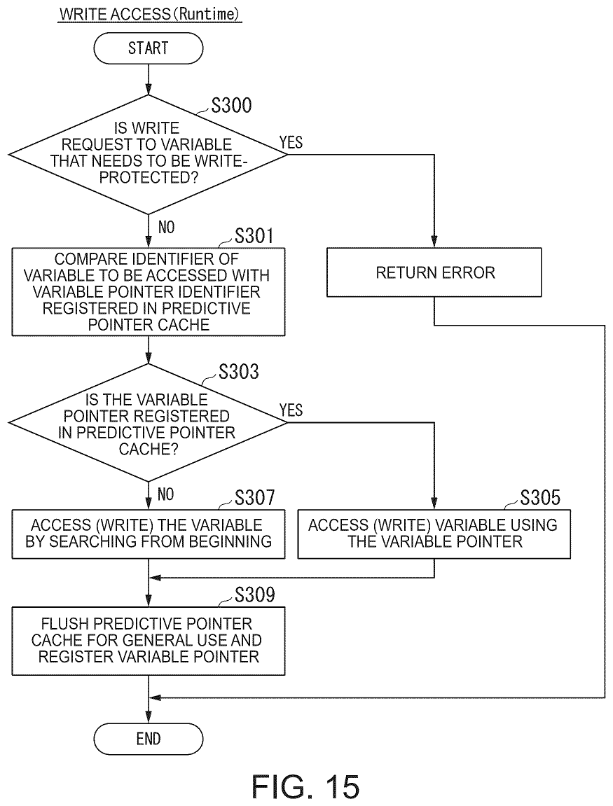

FIG. 15 is a flowchart of one example of the data access process for a write access after the POST processing (during runtime) according to one or more embodiments.

(Step S300) The processor 100 determines whether it is a writing request to a variable that needs to be write-protected. If the processor 100 determines that the request is to write a variable that needs to be write-protected (YES), the processor 100 returns an error and ends the procedure. If the processor 100 determines that the request is to write a variable that does not need to be write-protected (NO), the procedure proceeds to step S301.

(Step S301) The processor 100 compares the identifier of the variable to be write-accessed with the identifier of a variable pointer registered in the predictive pointer cache. Then, the procedure proceeds to step S303.

(Step S303) The processor 100 determines, based on the comparison result at step S301, whether the variable pointer of the variable to be write-accessed is registered in the predictive pointer cache. If the processor 100 determines that the variable pointer of the variable to be write-accessed is registered in the predictive pointer cache (step S303: YES), the procedure proceeds to step S305. If the processor 100 determines that the variable pointer of the variable to be write-accessed is not registered in the predictive pointer cache (step S303: NO), the procedure proceeds to step S307.

(Step S305) The processor 100 accesses the variable (variable to be write-accessed) using the variable pointer that was determined to be registered in step S303, and writes the value (data) to this variable. Specifically, the processor 100 invalidates the variable before it was written, writes the variable to another address in the RAM 110, and writes it back to the BIOS memory 22 (non-volatile storage) for synchronization (updating) of the data stored in the BIOS memory 22. This completes the write access process.

(Step S307) The processor 100 accesses the multiple variables stored in the RAM 110 by searching them one by one from the beginning, and writes the value (data) to the variable (variable to be write-accessed) whose identifier matches. Specifically, the processor 100 invalidates the variable before it was written, writes the variable to another address in the RAM 110, and writes it back to the BIOS memory 22 (non-volatile storage) for synchronization (updating) of the data stored in the BIOS memory 22. Then, the procedure proceeds to step S309.

(Step S309) The processor 100 registers the variable pointer of the variable write-accessed in step S307.

Specifically, the processor 100 flushes (erases) the predictive pointer cache for general use, and then registers the variable pointer indicating the address after writing to end the write access process. After the POST processing (during runtime), the processor 100 maintains the predictive pointer cache for protection.

As described above, the information processing apparatus 10 according to one or more embodiments includes: the processor 100 (e.g., a processor such as the CPU 11) that executes BIOS processing; and the RAM 110 (memory such as the main memory 12) that temporarily stores a plurality of pieces of data to be accessed by the BIOS processing. The processor 100 performs processing to store a variable pointer (data location information) indicating the address (location) within the RAM 110 of some of the multiple variables (examples of data) stored in the RAM 110 through BIOS processing in an area (e.g., a predictive pointer cache) separate from the area in the RAM 110 where the multiple variables are stored. Furthermore, when the processor 100 accesses one of the multiple variables stored in the RAM 110 through the BIOS processing, if the variable pointer of the variable to be accessed is not stored in the RAM 110, the processor 100 accesses the variable by searching the multiple variables stored in the RAM 110 in a predetermined order, and if the variable pointer of the variable to be accessed is stored in the RAM 110, the processor 100 accesses the variable in accordance with the variable pointer.

This allows the information processing apparatus 10 to directly access the variables (data) expanded in the RAM 110 using the variable pointer registered in the predictive pointer cache, thus speeding up access to the data by the BIOS.

For instance, in response to an access to one of the plurality of variables stored in the RAM 110 through the BIOS processing, the processor 100 registers (stores) the variable pointer of the accessed variable in the RAM 110.

This allows the information processing apparatus 10 to, when accessing a variable once accessed again, directly access the variable using the variable pointer registered in the predictive pointer cache, thus speeding up the access to data by the BIOS.

Each of the multiple variables is stored in the RAM 110 in association with its respective identifier (identification information). Then, in response to accessing one of the multiple variables, the processor 100 registers (stores) the identifier of the accessed variable and the variable pointer in the RAM 110 in association with each other.

This allows the information processing apparatus 10 to compare the variable pointer with the identifier when accessing the variable.

Furthermore, when the processor 100 reads one of the multiple variables through the BIOS processing, if the variable pointer of the variable to be read is not stored in the RAM 110, the processor 100 reads the variable by searching the multiple variables stored in the RAM 110 for access in a predetermined order (e. g., one by one from the beginning), and if the variable pointer of the variable to be read is stored in the RAM 110, the processor 100 accesses the variable in accordance with the variable pointer.

This allows the information processing apparatus 10 to directly access and read the variables (data) expanded in the RAM 110 using the variable pointer registered in the predictive pointer cache, thus speeding up access to the data by the BIOS.

The multiple variables include: a variable (first data) that may be written during the POST processing by the BIOS process but not be written after the POST process (during runtime); and a variable (second data) that may be written both during the POST process and after the POST process (during runtime). A variable that may be written during POST processing by BIOS processing but is not written after POST processing (during runtime) corresponds to a variable that needs to be write-protected. A variable that may be written both during the POST processing and after the POST processing (during runtime) corresponds to a variable that does not need to be write-protected. When storing variable pointers in the RAM 110, the processor 100 distinguishes a variable pointer of a variable that needs to be write-protected and a variable pointer of a variable that does not need to be write-protected, and registers (stores) them separately in a predictive pointer cache for protection (first area) and a predictive pointer cache for general use (second area) of the RAM 110.

This allows the information processing apparatus 10 to maintain and use the variable pointer of a variable that needs to be write-protected after POST processing (during Runtime).

Furthermore, when the processor 100 writes to one of the multiple variables through BIOS processing, it invalidates the variable before writing and writes the variable to another address (location) within the RAM 110. Then, the processor 100 accesses and writes to the variable based on a variable pointer stored in a predictive pointer cache for protection or a predictive pointer cache for general use. In this case, the processor 100 updates the variable pointer based on the address (location) of the variable in the RAM 110 after writing.

This changes a variable pointer when writing is performed to the variable through a write access, which allows the information processing apparatus 10 to appropriately update the variable pointer stored in the predictive pointer cache, and use it also for subsequent accesses.

When the processor 100 accesses and writes to a variable based on a variable pointer stored in the predictive pointer cache for protection, and when it updates the variable pointer, the processor 100 erases all of the variable pointers currently stored in the predictive pointer cache for protection, and then stores, in the predictive pointer cache for protection, a variable pointer indicating the address (location) in the RAM 110 of the variable after writing. When the processor 100 accesses and writes to a variable based on a variable pointer stored in the predictive pointer cache for general use, and when it updates the variable pointer, the processor 100 erases all of the variable pointers currently stored in the predictive pointer cache for general use, and then stores, in the predictive pointer cache for general use, a variable pointer indicating the address (location) in the RAM 110 of the variable after writing.

This allows the information processing apparatus 10 to easily and quickly update the variable pointer stored in the predictive pointer cache.

Furthermore, the processor 100 prohibits the erasure of the variable pointers stored in the predictive pointer cache for protection after POST processing (during runtime).

This allows the information processing apparatus 10 to use a variable pointer stored in the predictive pointer cache for protection to speed up accesses after POST processing (during runtime).

Furthermore, the processor 100 performs initialization so that the predictive pointer cache for protection and the predictive pointer cache for general use store no variable pointers at the start of the POST processing.

This allows the information processing apparatus 10 to start the POST processing in a state where no invalid variable pointers are left in the predictive pointer cache, thereby speeding up accesses during the POST processing.

The memory (e.g., RAM 110) that temporarily stores multiple pieces of data accessed by BIOS processing is a volatile memory that copies and temporarily stores BIOS data stored in a non-volatile memory (e.g., BIOS memory 22).

This allows the information processing apparatus 10 to expand data (e.g., variables) to be accessed by BIOS processing from the nonvolatile memory to the volatile memory and cache it, thereby speeding up the accesses.

The control method for the information processing apparatus 10 according to one or more embodiments includes: the processor 100 performing the following steps of: storing a variable pointer (data location information) indicating the address (location) within the RAM 110 of some of the multiple variables (examples of data) stored in the RAM 110 through BIOS processing in an area (e.g., a predictive pointer cache) separate from the area in the RAM 110 where the multiple variables are stored; and when the processor 100 accesses one of the multiple variables stored in the RAM 110 through the BIOS processing, if the variable pointer of the variable to be accessed is not stored in the RAM 110, accessing the variable by searching the multiple variables stored in the RAM 110 in a predetermined order, and if the variable pointer of the variable to be accessed is stored in the RAM 110, accessing the variable in accordance with the variable pointer.

This allows the control method for the information processing apparatus 10 to directly access the variables (data) expanded in the RAM 110 using the variable pointer registered in the predictive pointer cache, thus speeding up access to the data by the BIOS.

One or more embodiments show an example in which three variable pointers may be registered in each of the predictive pointer cache for protection and the predictive pointer cache for general use. The number of variable pointers that may be registered may be any number. However, if the number of variable pointers in the predictive pointer cache becomes too large, the time required to search within the predictive pointer cache increases, so the number of variable pointers may be small (e.g., may be about a few). The number of variable pointers that may be registered in the predictive pointer cache for protection and the predictive pointer cache for general use may be different.

Furthermore, in one or more embodiments, the variable pointer of a variable that has been accessed once is registered in the predictive pointer cache, but the registration in the predictive pointer cache is not limited to this. For instance, at least some of the variable pointers registered in the predictive pointer cache may be variable pointers of particular variables.

That is the detailed descriptions of the embodiments of the present invention, with reference to the drawings. The specific configuration of the present invention is not limited to the above-described embodiments, and also includes design modifications or the like within the scope of the present invention. For instance, the configurations described in the above embodiments can be combined freely.

The above-stated information processing apparatus 10 internally includes a computer system. A program to implement the functions of various configurations of the information processing apparatus 10 as stated above may be stored in a computer-readable recording medium, and the processing at the various configurations of the information processing apparatus 10 may be performed by causing the computer system to read and execute the program stored in this recording medium. “Causing the computer system to read and execute the program stored in the recording medium” includes installing of such a program in the computer system. The “computer system” here includes an OS and hardware, such as peripherals. The “computer system” may include a plurality of computer apparatuses connected via a network, including the internet and communication lines such as WAN, LAN and dedicated lines. The “computer readable recording medium” is a portable medium, such as flexible disk, a magneto-optical disc, a ROM, or a CD-ROM, as well as a memory internally stored in the computer system, such as hard disk. In this way, the recording medium to store the program may be a non-transient recording medium, such as a CD-ROM.

The recording medium also includes an internal or external recording medium where a distribution server can access to distribute the program. The program may be divided into a plurality of pieces. After these pieces of program may be downloaded at different timings, they may be combined by the configurations of the information processing apparatus 10. Alternatively, different distribution servers may distribute these divided pieces of program. The “computer readable recording medium” also includes the one that can hold a program for a certain period of time, as in a server that receives a program transmitted via a network or a volatile memory (RAM) in the computer system as the client.

The program may implement a part of the functions as stated above. The program may be a differential file (differential program) that can implement the above functions by combining it with a program which is already stored in the computer system.

A part or all of the functions that the information processing apparatus 10 of the above-described embodiments has may be implemented as an integrated circuit, such as a LSI (Large Scale Integration). Each of the functions as stated above may be implemented as one processor, or a part or all of the functions may be implemented as one processor in an integrated manner. A technique for integrated circuit is not limited to a LSI, and an integrated circuit may be realized using a dedicated circuit or a general-purpose processor. If a technique for integrated circuit that replaces LSIs becomes available with the development of a semiconductor techniques, an integrated circuit based on such a technique may be used.

### DESCRIPTION OF SYMBOLS

10 information processing apparatus
11 CPU
12 main memory
13 video subsystem
14 display unit
21 chipset
22 BIOS memory
23 storage medium
24 audio system
25 WLAN card
26 USB connector
31 embedded controller
32 input unit
33 power circuit
34 battery
100 processor
110 RAM

What is claimed is:

1. An information processing apparatus comprising:
a processor that executes basic input output system (BIOS ) processing; and
a memory that temporarily stores pieces of data to be accessed by the BIOS processing,
the processor being configured to
store data location information indicating a location within the memory of some of the pieces of data stored in the memory through the BIOS processing in an area separate from an area in the memory where the pieces of data are stored; and
when accessing one of the pieces of data stored in the memory through the BIOS processing, if the data location information on the data to be accessed is not stored in the memory, access the data by searching the pieces of data stored in the memory in a predetermined order, and if the data location information on the data to be accessed is stored in the memory, access the data in accordance with the data location information.

2. The information processing apparatus according to claim 1, wherein the processor is configured to, in response to accessing any of the pieces of data stored in the memory through the BIOS processing, store the data location information of the accessed data in the memory.

3. The information processing apparatus according to claim 2, wherein each of the pieces of data is stored in the memory in association with identification information of the data, and
the processor is configured to
in response to accessing to any of the pieces of data, associate the identification information of the accessed data with the data location information and store the associated information in the memory.

4. The information processing apparatus according to claim 1, wherein the processor is configured to, when reading one of the pieces of data through the BIOS processing, if the data location information on the data to be read is not stored in the memory, access and read the data by searching the pieces of data stored in the memory in a predetermined order, and if the data location information on the data to be read is stored in the memory, access and read the data in accordance with the data location information.

5. The information processing apparatus according to claim 1, wherein the pieces of data include: first data that may be written during the power on self test (POST) processing by the BIOS processing but not be written after the POST processing; and second data that may be written both during the POST processing and after the POST processing, and
the processor is configured to
when storing the data location information in the memory, store the data location information on the first data and the data location information on the second data separately in a first area and a second area in the memory.

6. The information processing apparatus according to claim 5, wherein the processor is configured to
when writing to one of the pieces of data through the BIOS processing, invalidate the data before writing and write the data to another location within the memory, and
when accessing and writing the data in accordance with the data location information stored in the first area or the second area, update the data location information based on the location of the data in the memory after writing.

7. The information processing apparatus according to claim 6, wherein the processor is configured to:
when accessing and writing the data based on the data location information stored in the first area, and when updating the data location information, erase all of the data location information currently stored in the first area, and then store the data location information indicating the location in the memory of the data after writing in the first area; and
when accessing and writing the data based on the data location information stored in the second area, and when updating the data location information, erase all of the data location information currently stored in the second area, and then store the data location information indicating the location in the memory of the data after writing in the second area.

8. The information processing apparatus according to claim 7, wherein the processor is configured to prohibit erasure of the data location information stored in the first area after the POST processing.

9. The information processing apparatus according to claim 5, wherein the processor is configured to, at a start of the POST processing, initialize the first area and the second area to a state in which the data location information is not stored.

10. The information processing apparatus according to claim 1, wherein the memory includes a volatile memory that copies and temporarily stores BIOS data stored in a non-volatile memory.

11. A control method for an information processing apparatus including a processor that executes BIOS (basic input output system) processing, and a memory that temporarily stores pieces of data to be accessed by the BIOS processing, the method comprising performing, by the processor:
storing data location information indicating a location within the memory of some of the pieces of data stored in the memory through the BIOS processing in an area separate from an area in the memory where the pieces of data is stored; and
when accessing one of the pieces of data stored in the memory through the BIOS processing, if the data location information on the data to be accessed is not stored in the memory, accessing the data by searching the pieces of data stored in the memory in a predetermined order, and if the data location information on the data to be accessed is stored in the memory, accessing the data in accordance with the data location information.
